(19) United States
(12) Patent Application Publication
(10) Pub. No.: US 2004/0112466 A1
(43) Pub. Date: Jun. 17, 2004

(54) Method and apparatus for labeling logs

(76) Inventors: Neil A. Roth, Plainfield, IL (US); Dennis D. Wetterich, Newark, IL (US)

Correspondence Address: CATERPILLAR INC., 100 N.E. ADAMS STREET, PATENT DEPT., PEORIA, IL, 616296490

(21) Appl. No.: 10/319,324

(22) Filed: Dec. 13, 2002

(51) Int. Cl. A01G 23/08; B42D 15/00

(52) U.S. Cl. 144/336; 283/67

(57) ABSTRACT

In a forestry operation, it is desirable to associate certain information, such as size, species, owner, or the like, with individual logs. Logs are normally stored for a time before processing, and an operator must be able to select certain logs meeting predetermined characteristics from the plurality of stored logs. The present invention provides a method and apparatus for labeling logs in such a way that the information associated with each log may be read from a remote location and the operator need not travel to each log to determine the characteristics of that log.

### TECHNICAL FIELD

This invention is a system for labeling logs and, more specifically, a system which allows individual log information to be obtained remotely.

### BACKGROUND

In the forestry industry, trees are cut down and the resulting logs are often stored in the woods for some time. This delay may allow time to “season” the wood or to wait until processing capability or a buyer is available. It is desirable to mark the logs somehow so that certain characteristics of each log are apparent to an operator returning to the woods to collect logs of a desired type. Currently, the industry practice is to mark the logs with certain colors of paint to indicate the log owner, type of wood, or the like, but this system is by no means standardized and the colors may have different meanings in different areas. Moreover, the amount of information that can be indicated by the paint is quite limited. It is also labor-intensive to manually mark the logs. An operator must be able to view the logs from a certain angle and distance in order to see the paint, which could cause the operator to travel out of his intended path and be unduly time-consuming. Finally, the paint can become weathered or obscured by brush while the logs are left in the woods, negating the advantages of the marking.

PCT International Application No. PCT/FI91/00039, published Sep. 5, 1991 (hereafter referenced as '39) discloses a method for marking logs in which a code number is placed, using an inkjet printer for example, on a worked surface of the log and data corresponding to that log is filed under the code number in a central memory bank. Unfortunately, the code number of '39 is subject to smudging and weathering and may be difficult to read later. The operator must get close enough to the log to visually read the code number, which may be difficult in areas having thick undergrowth. Also, the code number memory bank must be accessible and if the operator has not yet downloaded the memory of the cutting machine or if the master memory has become corrupted, the log data of '39 can be lost.

The present invention is directed to overcoming one or more of the problems as set forth above.

### SUMMARY OF THE INVENTION

In a preferred embodiment of the present invention, a log labeling system is disclosed. The log labeling system includes an electronic control module adapted to produce a label information signal, a label writer adapted to receive the label information signal and responsively produce a label, and a label applier adapted to associate the label with the log. The label contains individual log information and is readable from a remote location.

In a preferred embodiment of the present invention, a method of identifying a log is disclosed. The method includes the steps of: obtaining individual log information, producing a label including the individual log information, associating the label with the log, and reading the label from a remote location.

In a preferred embodiment of the present invention, a method for managing logs is disclosed. The method includes the steps of: cutting at least one tree to produce at least one log, labeling the log with individual log information, remotely reading the individual log information, and identifying the log having individual log information corresponding to at least one predetermined desired information value.

In a preferred embodiment of the present invention, a tree harvesting apparatus is disclosed. The tree harvesting apparatus includes a harvesting head adapted to sever the tree and controllably release the resulting log; and a log labeling system associated with the harvesting head. The log labeling system includes: an electronic control module adapted to produce a label information signal, a label writer adapted to receive the label information signal and responsively produce a label, and a label applier adapted to associate the label with the log, wherein the label contains individual log information and is readable from a remote location.

### BRIEF DESCRIPTION OF THE DRAWINGS

FIG. 1 is a side view of a tree harvesting apparatus including a preferred embodiment of the present invention.

### DETAILED DESCRIPTION

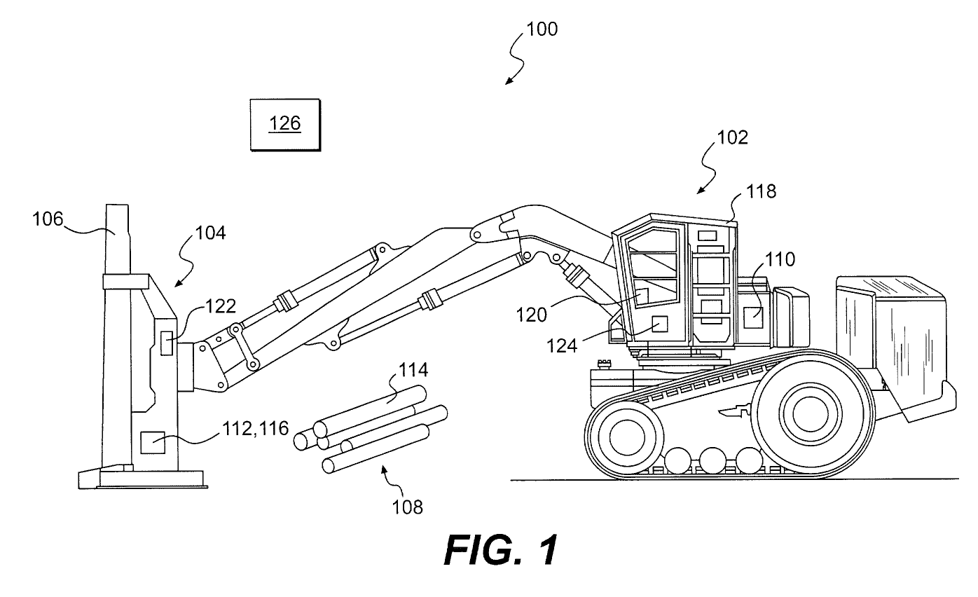

FIG. 1 depicts a tree harvesting apparatus 100 according to the present invention. Though the present invention may be utilized at any suitable step in the logging process, it will be described herein as occurring at the time of harvesting of the tree, for ease of reference. Other opportune times for implementing the present invention include, but are not limited to, when the log is being loaded onto a transport to a processing facility, and before the tree is harvested.

A work machine 102, for example, the harvester 102 shown in FIG. 1, carries a harvesting head 104 and is adapted to power and control the harvesting head 104. The harvesting head 104 severs a tree 106 and controllably releases the resulting log 108 in a known manner. A pile of logs 108 is shown in FIG. 1. The log 108 may be released and stored in the woods or may be taken to a central warehousing point by the work machine 102 carrying the harvesting head 104 or by any other suitable work machine 102, such as a forwarder, skidder, on- or off-highway truck, wheel loader, or the like. A log labeling system is associated with the harvesting head 104 in the embodiment shown in FIG. 1—as before, the log labeling system can be associated with any work machine 102 or with any step in the logging process. The log labeling system may also or instead be hand-held by the operator and carried to the log 108 or the tree 106 to be labeled.

The log labeling system includes an electronic control module (ECM) 110, which may be the same ECM 110 associated with the work machine 102, and which is adapted to produce a label information signal. A label writer 112 receives the label information signal and responsively produces a label 114, which is adapted to be remotely read. By “remotely read”, it is meant that an operator need not be near the log or in eyesight of the log to obtain the information from the label 114. Even if the operator is within sight of the log, the use of a non-visual device to receive information from the label 114 would fall under the meaning of “remote read”.

The label 114 is preferably a computer chip 114 or other device adapted to transmit the label information signal and may include some provision for powering the transmitter. The label 114 may also or instead be nonpowered and passively read, much like the proximity sensor-equipped identification badges used in many secured buildings. The label writer 112 could be a computer chip burner or another type of information encoder—the term “writer” does not necessarily connote literal writing. In addition to the label information signal, the label 114 may include information intended to be seen by an operator and collected in a known manner, such as visually-accessible writing or a bar code, without departing from the scope of the present invention.

A label applier 116 associates the label 114 with the log 108. The label 114 may be contacting the surface of the log 108, inserted or implanted into the log 108, attached to the log 108 by an intermediate member (such as a cable tie, adhesive, wire, or the like) or placed in any other location in which the label 114 identifies a log 108. In addition, a single label 114 could collectively identify a group of logs 108 and need not be associated with an individual log 108. (The label 114 will be described below, however, as being associated with a single log 108 for clarity.) The label 114 need not be visible by an operator before or after the log 108 is released from the harvesting head 104 in the embodiment in which the label 114 is associated with the log 108 during the harvesting process. Examples of suitable label appliers 116 include a device adapted to fire a label 114 enclosed in a bullet-type shell into the log 108, a device adapted to affix a label 114 to the log 108 in a staple-like manner, a device adapted to adhesively affix the label 114 to the log 108, a device adapted to tie the label 114 around a log 108 with or without an intermediate member, and any other device operable to associate a label 114 with a log 108 or group of logs 108.

The label 114 of the present invention contains individualized information about the log 108 with which it is associated. This individual log information may optionally be obtained manually and/or automatically. When log 108 information is obtained manually, the work machine 102 includes an operator interface 120, optionally located within an operator compartment 118. The operator interface 120 is adapted to receive an operator input and responsively produce an operator input signal, and the ECM 110 produces the label information signal at least partially responsive to the operator input signal. The operator input signal may contain information about and/or a value for one or all of: a log identifier (a unique code number), a log owner, a log species, an operator-produced log quality (“eyeballed” by the operator), a cut location, a log price, an operator identity, a cut date, and a cut time.

For automatically generated log 108 information, at least one of a log measurement system 122, a work machine location sensor 124, and the ECM 110 is preferably used. The log measurement system 122 is associated with the harvesting head 104 and senses physical characteristics of the log 108. The log measurement system 122 produces a log measurement signal which is then provided to the ECM 110 and the label information signal is responsively produced. The log measurement signal may contain information about, or a value for, at least one of: a measured log quality, a log weight, a log girth, a log length, a log diameter, and a log volume. The work machine location sensor 124 produces an automatic location signal, possibly using Global Positioning Satellite (GPS) technology, and the ECM 110 produces the label information signal responsive to the automatic location signal. The ECM 110 itself may generate a value specifying the cut date, cut time, and/or log identifier, which then would be included in the label information signal sent to the label writer 112. The ECM 110 preferably combines information and values from one or more of the operator input signal, log measurement signal, automatic location signal, and ECM-generated information to responsively produce the label information signal.

The ECM 110 may additionally compile a historical database of the label information signals for a plurality of logs. This database may be searchable by a log code number or may be a duplication of the label information signal. The label 114 on a log 108 would not necessarily include all of or the same information as in the historical database. The historical database may be stored in the ECM 10 or downloaded to a central database serving a plurality of work machines 102.

### INDUSTRIAL APPLICABILITY

When an operator wishes to obtain information about a log 108, a remote reading device 126 is employed to remotely read the label 114. The remote reading device 126 may be one or more of an automatic ground level scanner (possibly carried by a work machine 102), a handheld scanner, a satellite system, and the like. The label 114 need not be visible to the eye of the operator during the remote read, due to distance, obstruction, or any other factor.

Other aspects, objects and advantages of the present invention can be obtained from a study of the drawings, the disclosure and the appended claims.

What is claimed is:

1. A log labeling system, comprising:
an electronic control module adapted to produce a label information signal;
a label writer adapted to receive the label information signal and responsively produce a label, wherein the label contains individual log information and is readable from a remote location; and
a label applier adapted to associate the label with the log.

2. The log labeling system of claim 1, including an operator interface, the operator interface adapted to receive an operator input and responsively produce an operator input signal, and wherein the electronic control module receives the operator input signal and responsively produces the label information signal.

3. The log labeling system of claim 2, wherein the operator input signal includes at least one of: a log identifier value, a log owner value, a log species value, an operator-produced log quality value, a cut location value, a log price value, an operator identity value, a cut date value, and a cut time value.

4. The log labeling system of claim 1, wherein the label transmits a signal which is read by a remote reading device.

5. The log labeling system of claim 4, wherein the remote reading device is at least one of an automatic ground-level scanner, a handheld scanner, and a satellite system.

5. The log labeling system of claim 1, including a location sensor adapted to produce an automatic location signal, and wherein the electronic control module receives the automatic location signal and responsively produces the label information signal.

6. The log labeling system of claim 1, wherein the electronic control module compiles a historical database of the individual log information for a plurality of logs.

7. The log labeling system of claim 1, wherein the label is not visible to an operator when the label is being remotely read.

8. The log labeling system of claim 1, wherein the label is associated with the log by at least one of: contacting the surface of the log, being attached to the log by an intermediate member, and being inserted into the log.

9. The log labeling system of claim 1, wherein a single label is associated with a plurality of logs.

10. A method of identifying a log, comprising:
obtaining individual log information;
producing a label including the individual log information;
associating the label with the log; and
reading the label from a remote location.

11. The method of claim 10, including:
transmitting the individual log information from the label associated with the log.

12. The method of claim 10, wherein the step of reading the label from a remote location includes at least one of: reading the label with a handheld scanner, reading the label with an automatic ground-level scanner, and reading the label with a satellite system.

13. The method of claim 10, wherein the step of collecting individual log information includes collecting a value for at least one of: a log identifier, a log owner, a log species, an operator-produced log quality, a cut location, a log price, an operator identity, a cut date, a cut time, a measured log quality, a log weight, a log girth, a log length, a log diameter, and a log volume.

14. The method of claim 13, wherein the step of collecting a value for at least one of the log identifier, log owner, log species, operator-produced log quality, cut location, log price, and operator identity includes inputting of the value by an operator.

15. The method of claim 13, wherein the step of collecting a value for at least one of the log identifier, cut location, cut date, cut time, measured log quality, log weight, log girth, log length, log diameter, and log volume includes automatically providing the value using sensors.

16. The method of claim 10, wherein the step of reading the label from a remote location includes positioning at least one of the label and a remote reading device such that the label is not visible to an operator of the remote reading device.

17. The method of claim 10, wherein the step of associating the label with the log includes at least one of: contacting the log with the label, inserting the label into the log, attaching the label to the log using an intermediate member, and associating the label with a plurality of logs.

18. A method for managing logs, comprising:
cutting at least one tree to produce at least one log;
labeling the log with individual log information;
remotely reading the individual log information; and
identifying the log having individual log information corresponding to at least one predetermined desired information value.

19. The method of claim 18, wherein the step of labeling the log with individual log information includes labeling the log with an individualized value for at least one of: a log identifier, a log owner, a log species, an operator-produced log quality, a cut location, a log price, an operator identity, a cut date, a cut time, a measured log quality, a log weight, a log girth, a log length, a log diameter, and a log volume.

20. A tree harvesting apparatus, comprising:
a harvesting head adapted to sever the tree and controllably release the resulting log; and
a log labeling system associated with the harvesting head, including:
an electronic control module adapted to produce a label information signal;
a label writer adapted to receive the label information signal and responsively produce a label; and
a label applier adapted to associate the label with the log, wherein the label contains individual log information and is readable from a remote location.

21. The tree harvesting apparatus of claim 20, including a log measurement system associated with the harvesting head and adapted to produce a log measurement signal, wherein the label information signal is produced responsive to the log measurement signal.

22. The tree harvesting apparatus of claim 21, wherein the log measurement signal contains at least one of: a log identifier, a measured log quality value, a log weight value, a log girth value, a log length value, a log diameter value, and a log volume value.

23. The tree harvesting apparatus of claim 20, including a work machine connected to the harvesting head and adapted to power and control the harvesting head.
